(19) United States
(12) Patent Application Publication
(10) Pub. No.: US 2025/0371132 A1
(43) Pub. Date: Dec. 4, 2025

(54) METHOD AND SYSTEM

(71) Applicant: Mindgard Limited, London (GB)

(72) Inventors: Peter GARRAGHAN, Lancaster (GB); Neeraj SURI, Lancaster (GB)

(73) Assignee: Mindgard Limited, London (GB)

(21) Appl. No.: 19/105,628

(22) PCT Filed: Jun. 15, 2023
(86) PCT No.: PCT/GB2023/051574

§ 371 Date: Feb. 21, 2025

(30) Foreign Application Priority Data
Aug. 23, 2022 (GB) 2212217.0

(51) Int. Cl. G06F 21/53; G06F 21/55; G06F 21/57

(52) U.S. Cl. CPC G06F 21/53; G06F 21/552; G06F 21/554; G06F 21/577

(57) ABSTRACT

A method and system is provided which enables the operating environment around an ML model to be monitored to determine whether an attack is taking place. A method and system is provided enables the ML model to be analysed in a framework independent manner.

The present invention relates to a method and system. Particularly, but not exclusively, the invention relates to a computer-implemented method and a computer implemented system.

Machine Learning (ML) and its subset Deep Learning (DL) have seen wide adoption in medical, financial, security and other applications, and in some industries are viewed as mission-critical assets. The growth in application of these techniques to real-world problems has lead to hitherto unseen levels of automation in multiple fields and the commercial and societal value of these models means they are a target for attack.

The rapid growth of technology which applies proprietary, commercially valuable ML and DL models has made them an attractive target for cyber attackers. There exist various different form of attacks, spanning model extraction, wherein an attacker attempts to steal some or all fundamental characteristics of a target model that can then be reconstructed. Another attack is model inversion that generates images that represent ML model classes (a facial recognition model can be attacked to generate data to represent a real person), model evasion whereby the attacker attempts to avoid an ML model's classification, and data poisoning whereby an attack manipulates training data of an ML models to control its predictive behaviour. These attacks can also be used in conjunction, for example a stolen model can then be used for further adversarial attacks, such as extracting the training data from a model in an inversion attack, or using the knowledge acquired to build a replica of similar performance without the cost of research and development.

Thus there is a need to prevent such cyber attacks. However, this is not possible without an understanding of a ML system's vulnerability to such attacks, and/or a means of detecting an attack.

Aspects and embodiments are conceived with the foregoing in mind.

Viewed from a first aspect, there is therefore provided a computer-implemented method of detecting an attack on an Machine Learning (ML) model operating environment hosted on a processing medium, the method implemented on a processing resource, the method comprising monitoring all requests from computing devices to the processing medium, determining that a request from at least one computing device is a request to access an ML model operating environment, determining from the request, the presence of data indicative of an attack and, if data indicative of an attack can be determined from the request, rejecting the request and, if data indicative of an attack cannot be determined from the request, enabling the request to access the ML model and monitoring the ML model operating environment to determine patterns of resource use indicative of suspicious behavior.

A method in accordance with first aspect enables the operating environment around an ML model to be monitored to determine whether an attack is taking place.

The processing resource may be software or hardware implemented. The processing resource may be implemented using cloud infrastructure. The processing resource may be configured to intercept all requests made to the processing medium.

Monitoring all requests from computing devices to the processing medium may comprise receiving the request and applying a processing step to determine the content of the request. Suspicious intent of the request may be determined from an internet protocol (IP) number of a specific geographic origin. Suspicious intent of the request may be determined using a neural network applied to the request to determine features indicative of suspicious intent. The neural network may be trained to receive parts of the request as input and to provide an output which predicts that the request is malicious. This may be, by, for example, determining that a feature has been added to an image which will facilitate an evasion attack. The neural network may be trained to determine the presence of an adversarial attack such as, for example, an extraction attack, or a data poisoning attack or a model evasion attack.

An ML model is configuration or architecture of neural networks which are deployed to utilise the principles of a trained neural network to provide an output responsive to an input. The input to the ML model may represent some physical parameters determined from, for example, sensors or physical measurements. The ML model may be trained to provide predictive output indicating that the input corresponds to an output. An ML model may be trained using supervised or unsupervised methods used to determine the weights and biases a neural network or a plurality of neural networks. Example neural networks may be artificial neural networks, generalised neural networks, recurrent neural networks, convoluted neural networks and deep neural networks. An ML model may also comprise a model which provides predictive outputs based on a trained model which receives an input. An ML model may also apply further statistical analysis to inputs or outputs to extrapolate features of the input or output based on a trained neural network or historical data. An example of an ML model may be a Deep Learning (DL) model. A deep learning model may be described as a trained model which may apply a nonlinear transformation to an input and utilises a plurality of neural networks and layers to produce a statistical prediction of an output based on the input. The plurality of neural networks may comprise a combination of one or more of artificial neural networks, generalised neural networks, recurrent networks and convoluted neural networks and deep neural networks. A DL model may be layered in the sense that an output from a first layer comprising a combination of one or more neural networks may be fed into one or more subsequent layers comprising one or more further neural networks. Anyone of the layers in an ML model or DL may receive input from an external source such as a sensor or a data feed.

An ML model operating environment includes the ML model itself and the hardware and software resources which are needed to implement the model. This may include hardware, operating systems, application programming interfaces and data sources. The ML model operating environment may be implemented using one or more processors and may be software or hardware based and may be implemented using a virtual machine.

The ML model operating environment may alternatively or additionally be implemented using a containerised environment where the ML model may be configured to run in isolation from other applications accessing the same hardware, even though the ML model may be sharing the same operating system. That is to say, the ML model may be a process executing on a host operating system alongside other processes. The other processes may also be ML models.

The processing medium may comprise any item of hardware or software (or cloud-based apparatus) which can provide processing capacity. The processing medium may comprise one or more processing resources.

Suspicious behavior may be determined by a threshold which indicates normal operating levels for a metric which represents the activity levels within the operating environment which is being used to implement the ML model. Such a threshold may indicate, for example, normal levels of resource access, normal levels of memory access, average number of requests to the ML model. A normal level may be indicated by statistical analysis of historical data relating to the metric. An example of a resource access may be a hardware access request such as a request for CACHE access. Alternatively, a cache access request may also be an example of a software access request where CACHE is implement using software. For example, excessive CACHE access may exceed a threshold which indicates it is likely to be excess and could be indicative of a specific attack on the hosted ML model. For example, the suspicious behaviour may come from higher than average levels of CACHE flushing where an attach flushes the CACHE to flush the cache to cause programs to run slower when then move data back into the cache to be used. In another example, requests to access a register may also exceed a normal level of request and this may also indicate suspicious behaviour.

Monitoring the ML model operating environment to determine patterns of resource use indicative of suspicious behavior may comprise monitoring the operating environment to determine patterns of behavior indicative of an attack on the ML model. Examples of such attacks include an extraction attack, an evasion attack, a data poisoning attack or a mode evasion attack. Such patterns of behavior may be determined by higher than expected levels of CACHE access, or memory access, or network connection requests.

Monitoring the ML model operating environment to determine patterns of resource use indicative of suspicious behavior may comprise monitoring at least one of system metrics, hardware usage, output from the ML model and monitoring the use of classifications in the ML model identified as vulnerable. A classification may be identified as vulnerable if it is deemed as enabling for an attack on an ML model. For example, for an image recognition ML model, a vulnerable classification may be one which causes the model to mis-identify the presence of an object of interest in an image.

The determination of the presence of data indicative of an attack may be based on an external source of data. For example, a news source may indicate that an attack is being developed which attacks a specific aspect of an ML model and the suspicious behaviour metrics may be determined based on that news source. The determination of the presence of data indicative of an attack may comprise the application of at least one neural network to the request data. The at least one neural network may be trained on data which is determined from suspicious behaviour metrics. The at least one neural network may be trained using supervised or unsupervised techniques. The at least one neural network may be a convolutional neural network (CNN). The at least one neural network may be any time of neural network. For example, the at least one neural network may be a Recurrent Neural Network (RNN) or a Transformer or a Generalised Regression neural network or a Generative Adversarial Network (GAN). The at least one neural network may comprise a collection of the same type of neural network or distinct types of neural networks. The determination of data indicative of an attack may be based on information provided by an external news source or an administrator of an ML model.

A neural network may be an artificial neural networks (ANN) which are otherwise known as connectionist systems and are computing systems vaguely inspired by the biological neural networks. Such systems “learn” tasks by considering examples, generally without task-specific programming. They do this without any a prior knowledge about the task or tasks, and instead, they evolve their own set of relevant characteristics from the learning/training material that they process. ANNs are considered nonlinear statistical data modeling tools where the complex relationships between inputs and outputs are modeled or patterns are found.

ANNs can be hardware- (neurons are represented by physical components) or software-based (computer models) and can use a variety of topologies and learning algorithms. The ANN may have a plurality of hidden layers, usually ANNs have at least three layers that are interconnected but may have more than three layers. The first layer consists of input neurons. Those neurons send data on to the second layer, referred to a hidden layer which implements a function and which in turn sends the output neurons to the third layer. With respect to the number of neurons in the input layer, this parameter is based on training data. The layers may be connected by weights and biasing values. The weights and biasing values may be optimised using forward and backward propagation.

The second or hidden layer in a neural network implements one or more functions. For example, the function or functions may each compute a linear transformation or a classification of the previous layer or compute logical functions. For instance, considering that the input vector can be represented as x, the hidden layer functions as h and the output as y, then the ANN may be understood as implementing a function f using the second or hidden layer that maps from x to h and another function g that maps from h to y. So the hidden layer's activation is f(x) and the output of the network is g(f(x))

CNNs can be hardware or software based and can also use a variety of topologies and learning algorithms.

A CNN usually comprises at least one convolutional layer where a feature map is generated by the application of a kernel matrix to an input image. This is followed by at least one pooling layer and a fully connected layer, which deploys a multilayer perceptron which comprises at least an input layer, at least one hidden layer and an output layer. The at least one hidden layer applies weights to the output of the pooling layer to determine an output prediction.

The neural network may be trained using data from a pre-run attack. A pre-run attack is an attack which has already been tested on the ML model and the ML model operating environment. The attack may be devised by an administrator of the ML model. The data returned from the attack may well be stored in a data repository where the input data, output data and data indicating hardware and resource usage from the attack is also stored. The pre-run attack may be tested on the ML model in a secure execution environment. The pre-run attack may be defined using an attack scenario description which defines the attacks to undertake on the ML model and the time for those attacks. The attack scenario description may be set out in a JSON or YAML file, for example, or any other suitable file.

Viewed from a second aspect, there is provided a computer-implemented method of assessing the effect of an attack on a machine learning model, the method implemented on a processing resource, the method comprising the steps of receiving parameters describing the configuration of an attack, retrieving a machine learning (ML) model and loading it into an environment, retrieving a dataset and loading it into said model, retrieving data describing said attack. The method may further comprise implementing or executing the attack in the environment.

Parameters describing the configuration of an attack may describe the type of attack (e.g. model evasion, extraction, etc), a timeline for the attack or an identifier for the attacker (e.g. nation state)

The attack may be defined using an attack scenario description file which may be in a JSON or YAML format, or any other suitable format. The method may be repeated for a plurality of attacks specified in an attack scenario description file, where each iteration either repeats the same attack as the previous iteration or implements a different attack from the previous iteration.

Retrieving an ML model may comprise accessing an ML model in storage. Loading the ML model into an environment may comprise initialising the hardware and software resources necessary to implement the ML model and then placing the ML model into the memory. Responsive to the loading of ML model, it may then be run in accordance with the specified attack parameters. Each aspect of the operating environment may then be monitored.

Retrieving data describing the said attack may comprise monitoring the layers of the stack implemented by the environment and measuring access and usage patterns for each layer. The measurements of access and usage patterns for each layer is used to determine metrics which may indicate an attack is taking place. This data relating to metrics and which indicates suspicious behavior may be used to train neural networks as utilised in the first aspect.

A method in accordance with the second aspect provides a way of testing an attack on an ML model to establish its robustness to such an attack and also to establish the resource usage and input and output values which could be generated by such an attack. The method in accordance with the second aspect enables this to be performed in a secure, framework independent way.

The environment provides the libraries and other resources (both hardware and software) which are needed to run the model. The environment may comprise a Web API which can act as an attack surface for an attack and the loaded attack may be configured to use the Web API to launch the attack inside the environment. The environment may be an ML model operating environment.

An ML model operating environment includes the ML model itself and the hardware and software resources which are needed to implement the model. This may include hardware, operating systems, application programming interfaces and data sources. The ML model operating environment may be implemented using one or more processors and may be software or hardware based and may be implemented using a virtual machine. The components of the ML model operating would also be considered attack surfaces.

The ML model operating environment may alternatively or additionally be implemented using a containerised environment where the ML model may be configured to run in isolation from other applications accessing the same hardware, even though the ML model may be sharing the same operating system. That is to say, the ML model may be a process executing on a host operating system alongside other processes. The other processes may also be ML models. The environment may be a secure execution environment.

The method may further comprise monitoring the environment whilst the attack is executed; and recording the attack data as data describing the attack. The attack data may be timestamped to determine the time at which it was recorded. The effect of this is that the evolution of the data related to the attack can be determined and used to assess how such an attack would evolve if it were to be implemented against the ML model.

Executing the attack in the environment may comprise loading the dataset into the model and then executing an attack scenario as set out in a configuration file. The configuration file may, for example, be a JSON or an YAML file. The configuration file sets out the pipeline for the attack scenario and designates at which time, which components of the stack which implements the model are going to run, which may include designation of a required library. The attack scenario may be stored in an attack repository which includes the code for the attack and the parameters for the attack. The configuration file may designate those resources required by the attack, e.g. access to CPU cache, web API service, pseudo-access to programs, co-location programs and network connections. The configuration file sets out a list of tasks which may describe the attack, e.g. which data and which resource should be accessed at which time. A wrapper or API may be provided to enable the attack to connect with other effects of the system or stack there should be a wrapper or API.

The monitoring of the environment may comprise monitoring at least one of: resource usage, system usage, network connections, input and output from the ML model and parameters of the ML model.

The method may further comprise utilising the data to train a neural network to determine the presence of the attack or a similar attack.

That is to say, the data recorded from the attack may be used to train a neural network to recognise such an attack. This neural network may be implemented in an intrusion detection module which may be implemented to monitor the traffic which is passed to a server which is hosting such an ML model. This means that if the same attack or a similar attack, i.e. with the same intentions, were to be conducted against the ML model when it is deployed then it could be easily detected and countermeasures could be quickly deployed.

The method may further comprise analysing the data from the said attack by scoring the robustness of the model against a predefined suite of ML model attacks. The method may further comprise determining risk and loss associated with the attack on the ML model. The analysis may be implemented using a threat inference engine.

The method may further comprises analysing the data from the said attack to identify potential security vulnerabilities. The method may further comprise identifying improvements in the model to enable resistance against the identified security vulnerabilities.

The threat inference engine enables risk and loss associated with a specific ML model to be estimated. Scoring how robust the model is against a designed suite of model attacks across all types; extraction model inversion, poisoning, etc. Highlighting potential security concerns and recommendations on how to make the model more secure (Data for determining this is derived from monitoring models and applying countermeasures). The result allows a company to evaluate the security of their model before deploying it.

The ML model may be translated into a model representation language, wherein the model representation language enables the ML model to be analysed in a framework independent manner.

An embodiment of the present invention will now be described by way of example only with reference to the accompanying drawings where:

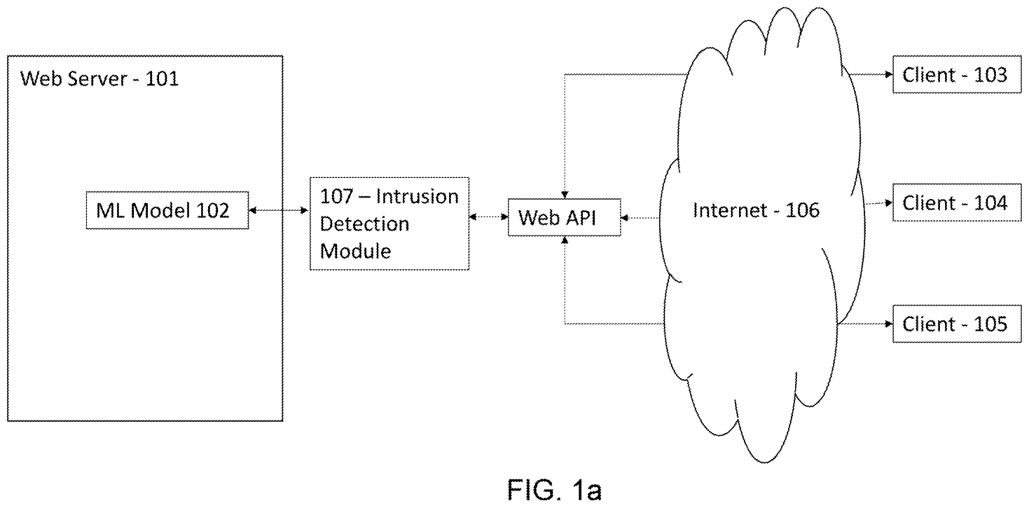

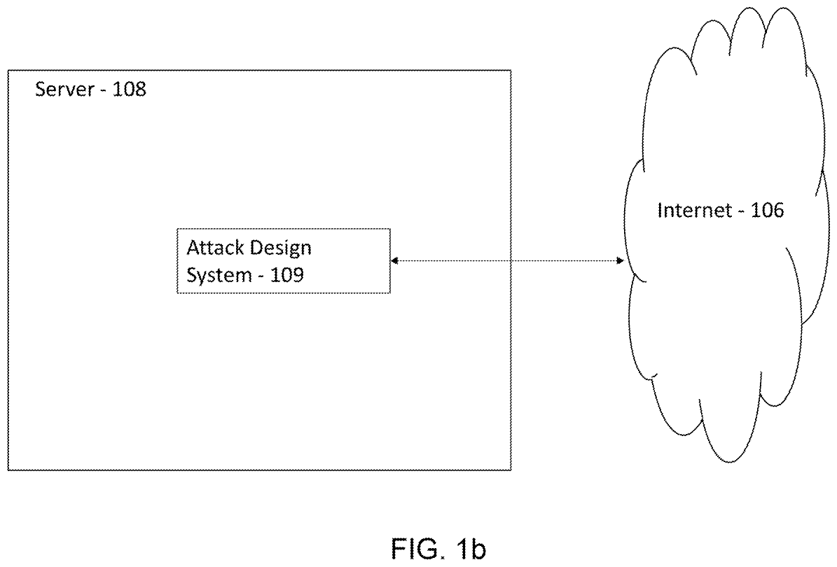

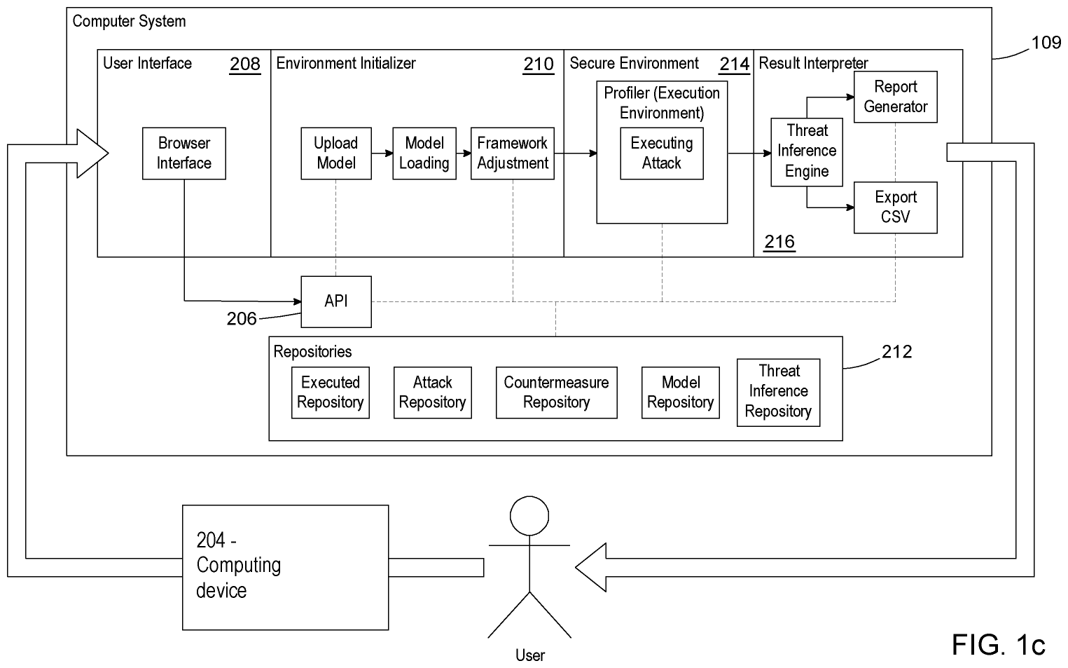

FIG. 1a illustrates an ML model hosted on a web server;

FIG. 1b illustrates an attack design system hosted on a server;

FIG. 1c illustrates an attack design system in accordance with an embodiment;

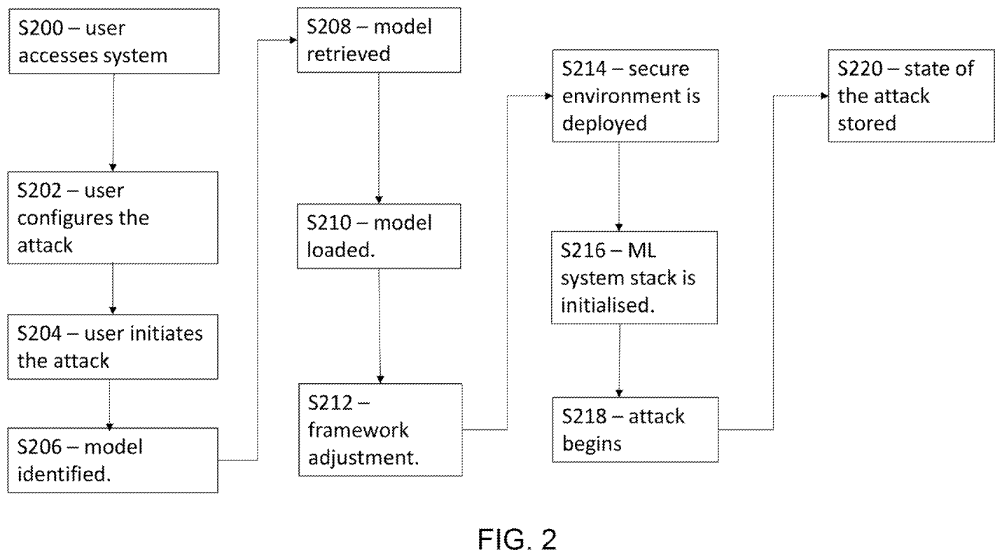

FIG. 2 illustrates the flow associated with use of attack design system to evaluate an ML model in accordance with the embodiment;

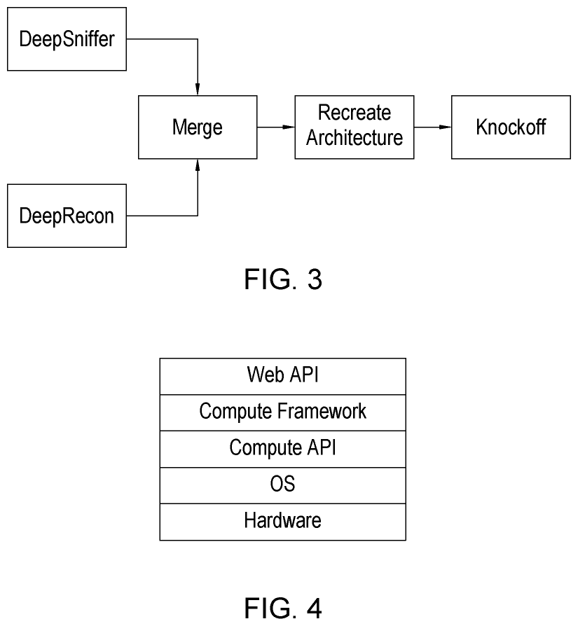

FIG. 3 illustrates an ensemble attack which may be implemented using the attack design system;

FIG. 4 illustrates a stack which may be used to categorise the attack on an ML model; and

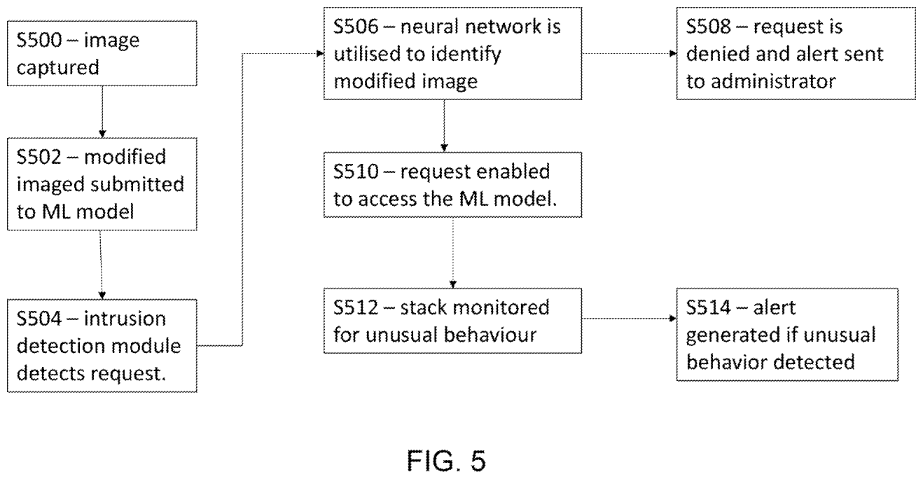

FIG. 5 illustrates the steps of detecting an attack on an ML model in accordance with the embodiment.

FIG. 1a shows an environment in which the invention may be implemented. Web server 101 hosts a ML model 102 having a web API that may be accessed by any of clients 103, 104 and 105 via Internet 106. Server 101 may be any type of suitable computing system, and may comprise more than one computing device in more than one location as is known in cloud computing. ML model 102 may be any kind of machine learning or deep learning model, with any suitable architecture and API. In this example, model 102 is accessible via Internet 106, but it could also be hosted on-premises on a local network.

Clients 103 to 105 may be any type of computing device connected in any way to Internet 106. Unbeknown to the administrators of ML model 102, client 105 is a threat actor mounting an adversarial attack on the model.

Intrusion detection module 107 is connected to server 101 and all traffic to and from the ML model 102 passes through it. That is to say, any traffic which is directed to the ML model 102 as a result of a request using the web API accessed by any of clients 103, 104 and 105 passes through intrusion detection module 107.

Intrusion detection module 107 identifies patterns in the data indicative an attack, such as the attack being mounted by client 105, and flags this to the administrators of ML model 102. The intrusion detection module 107 is configured to monitor system metrics, hardware usage of the ML model 102 and the outputs from the ML model 102 to determine the likelihood of suspicious activity. For example, the intrusion detection module 107 may determine that a number of requests to access the ML model 102 per minute has exceeded a specific access threshold, indicative of an attempt to attack the ML model.

The intrusion detection module 107 may deploy an artificial neural network comprising an input layer, at least one hidden layer and an output layer, wherein the artificial neural network may be configured to provide an output probability that a particular set of input parameters (determined from incoming traffic) represents an attack on the ML model 102. The weights of the respective layers may be optimised using a gradient descent approach and backpropagation to train the artificial neural network to identify that parameters determined from incoming traffic represents an attack. The training data may comprise data gained from attacks which have taken place elsewhere or from the attack repository which will be described below

The intrusion detection module 107 may be configured to deploy more than one artificial neural network wherein each of the neural networks are trained to determine a specific attack type. For example, one of the neural networks may be trained to identify an attack based on unusual hardware usage, whereas a second one of the neural networks may be trained to identify an attack based on system metrics. The intrusion detection module 107 may be configured to utilise neural networks which are trained to detect multiple attacks (either simultaneously, substantially simultaneously, in sequence or in some other specified order). The intrusion detection module 107 may determine features of attacks in a set of attacks which are similar, such as IP addresses or data-sets.

The intrusion detection module 107 is further configured to generate a response alert when suspicious activity is detected based on the traffic passing through the intrusion detection module 107. Upon determining the suspicious activity, the response alert is generated and may comprise at least one of a plurality of actions. These actions range from the delivery of an alert to a designated contact or a deployment of a countermeasure to mitigate the detected suspicious activity based on the environment in which the ML model 102 is deployed, the frequency of the activity and the potential severity of the activity.

As illustrated in FIG. 1b, server 108 hosts an attack design system 109, also accessible via Internet 106. As will be described below, the attack design system 109 enables an attack to be configured in a configuration file in a suitable format such as JSON or YAML. The attack may comprise multiple attacks which are chain together (which may be called an attack scenario)

Again, server 108 may be any type of suitable computing system, and may comprise more than one computing device in more than one location. Users of the service provided by attack design system 109, for example the administrators of ML model 102, may configure an attack to be run in a secure environment on the ML model 102, in order to identify threats and risks.

In FIG. 1c, we set out in detail the component modules of the attack design system 109. As will be described, the attack design system 109 enables a user to rapidly select a model (e.g. model 102), pick an attack on that model, select a scenario in which to apply that attack, select a dataset for that attack and then configure the attack using those options. The attack design system enables a timeline to be generated which sets out which attack happens on which component of the stack and when. This may include commands to load data at a first specific time in the attack, access cache at a second specific time in the attack, make a network connection at third specific time and other actions which may take place during a real attack. One example would be the selection to attack model 102 a specified number of times using a user interface and indicate that you wanted to mimic a nation state. As will be described, the attack design system 109 can then generate that scenario by pulling a collection of data from a repository.

Identification and examination of a potential threat actor is important for the assessment of potential attack scenarios. A potential threat actor (i.e nation-state, disgruntled employee, etc) can be quantified by their literal capability: time available (hours to months), access to funds and technology, and level of access to the system, skill (quantified by collective years of experience). The effectiveness (or at least effectiveness in a given window of time) of an attack is directly tied to an actor's capability; an API attack executing queries on one machine is far less effective than 10,000 machines due to the amount of data they can collect.

We now describe, with reference to FIG. 2, how the components of the attack design system 109 interact to enable the user to rapidly select a model for attack.

In a first step S200, the user 202 access the system 109 using their device 204. Device 204 can be any computing device which is configurable to access the system 109. That is to say, device 204 is any computing device which can access API 206. The access to the API 206 may be provided through a user interface module 208 which provides a user interface to the device through a web browser which can be viewed on the device 204.

Using the user interface, the user can configure their attack by selecting the ML model for attack (e.g. model 102), the framework for their attack, the dataset they wish to use for their attack, the depth of the analysis they wish to perform on the attack, the attack scenario, the type of attack (e.g. adversarial AI based attack), the required hardware and software resource access points for their attack, the parameters of the attack (e.g. how many times they wish to attack the model) and the type of threat actor they would like to represent when carrying out the attack (e.g. nation state). This is step S202. On selection of the parameters, the user provides input indicating they would like to proceed with the attack. This is step S204. This initiates the attack on the selected model. For the purpose of this example and only for the purpose of this example, we will use the example of ML model 102.

The user may also configure the attack in other ways using the user interface. For example, the user may select that the attack should be a single attack or a pipeline of attacks (which each return a result). For example, the first attack could be an extraction attack, the second attack could be an evasion attack and the next attack could be an evasion attack with different parameters. In another example, the user may utilise multiple attacks chained together (i.e. one after the other). In another example, the user may specify how and when each attack in the sequence of multiple attacks may be implemented.

The attack may be described in a JSON hierarchy to the API 206. The JSON hierarchy may utilise a hierarchy of JSON files to describe the execution of the attack using the attack design system. Generally, the flow of the attack can be described as a JSON hierarchy as an attack scenario which sets out the target model (i.e. model 102), the attack (e.g. single attack or ensemble attack), the attack pipeline (i.e. multiple attacks together), the operation of the attacks (i.e. how the results of one attack should be used as the input for another), the operation type and the selected attack types to perform the operation. A third level in the hierarchy may simple provide the name and the settings of the attack.

The JSON hierarchy may set out which components of the model and/or environment and/or framework are going to run and the output which will be stored in the attack repository in repositories module 212.

Alternatively the attack scenario may be described in a YAML file or any other suitable markup language/language independent interchange protocols such as BSON, XML or a Protocol Buffer. A protocol buffer may be advantageous as it offers improved speed of execution and compilation.

In this example, the attack scenario could be an ensemble attack as illustrated in FIG. 3 which would be deployed against ML model 102. This is specified in step S202 where the parameters of the attack are specified. The attack scenario in this example, utilises three different attacks but may use more or less different attacks. They may also use multiple versions of the same attack concurrently or in sequence. They may deploy different attacks concurrently or in a sequence. In the illustrated example, there are three example attacks. They are DeepSniffer (an architecture attack), DeepRecon (an architecture attack) and KnockOff (an API attack) where the results of DeepSniffer are merged together to predict the architecture of ML model 102. The information regarding the predicted architecture of ML model 102 is then used to generate a full model which can be used in the KnockOff attack. This is an example of an attack scenario which uses a pipeline whereby results of one attack are passed onto another when compared to just simply performing a single attack. The specific names given to the attack may be saved against specific sets of parameters, datasets and environments so that they can be retrieved easily and used to easily identify the attack by user's of the system. Alternatively or additionally, if a user “Rhodri” modified the parameters of DeepSniffer then he could save his modification as “RhodriDeepSniffer” so that can easily identify it as an attack that Rhodri configured.

On receiving the request via the API 206, the environment initializer module 210, in a step S206, identifies from the request that the user wishes to carry out an attack on ML model 102. This is the same ML model 102 as is deployed on web server 101. This illustrates how a user may utilise the attack design system 109 to attack their own models.

The environment initialiser module 210 may be able to utilise intermediate model representation languages, e.g ONNX or TVM IR to enable a model utilising an incompatible or optimised framework to be translated into a format in the intermediate model representation language which makes the environment initialiser module able to profile the ML model in a framework independent manner. This is not necessary for natively supported frameworks.”

The API 206 provides an intermediate layer between the user and the attack design system 109. The API enables the data, the ML model, the attack and the environment to be integrated together. The API also enables additional data relating to the attack integration to be generated and also can be used to specify how the data from pipelined attacks can be transmitted between attacks.

ML model 102 is a pretrained model which comprises an artificial neural network which comprises an input layer, two hidden layers and an output layer. The hidden layers are connected with pre-optimised weights which have been optimised using a suitable approach such as gradient descent and backpropagation. That is to say, the weights are stored as part of the model.

The environment initialiser module 210, in a step S208, retrieves the model from the model repository in repositories module 212. The environment initialiser module 210, in a step S210, loads the ML model 102 with the pre-optimised weights. The model is contained in a file and may be defined as a piece of computer program code which runs a neural network. The neural network comprises a specific layout of neurons, input layers, output layers and hidden layers, each connected by specific weights and paths between neurons. This may be described as the architecture of the ML model 102. The ML model 102 enables a set of numbers to be input, which may represent some physical measurements, for example, and for a classification of that input to be provided as an output. The code which is used to implement the model is often written in Python or C using a Python framework such as Pycharm or Tensorflow and the architecture is implemented using TensorFlow. Checkpoints and saved states (of the neural network or respective neurons in the neural network) can be added during training and may contain the weights and biases of the model.

Pytorch, TensorFlow, MXNet, Paddle Paddle are frameworks that enable design of DL models at a high level of expression—e.g. by using higher level languages such as Python. Under the hood, individual parts of such a high-level specification are translated/transpiled into lower level representation languages or bytecode (C, C++, Assembly, CUDA/ROCM for GPU devices) to be then executed in some order on the device (CPU, GPU). Pytorch, TensorFlow can be thought of foremost as design frameworks that also enable in-production execution of models.

The model repository may provide common pre-trained deep learning (DL) models. Common pre-trained DL models are popular models primarily from literature. Specifically, we may use ResNet, VGG, AlexNet, SqueezeNet, DenseNet, Inception, GoogleNet, RegNet and ConvNeXt. The model repository may also use a dataset such as MNIST, Cifar or ImageNet.

Pre-trained models aid in the prototyping of proprietary models as pre-trained models of a certain technology or architecture (i.e Transformers) can be tested for resilience against attacks that are of the greatest concern to a user. If that pre-trained model is resilient, a company could produce a proprietary model based on the techniques utilised in the pre-trained one. If a Transformer is very weak against types of side-channel attack, Transformers could be avoided.

The loading stage (in step S210) may also identify any differences in the ML model 102 or framework of the which would impact on the profiling stage (described below). The framework for the ML model 102 provides the tools or libraries which are used in the ML model 102. An example framework which is suitable for the ML model 102 may be TensorFlow, Shogun, Sci-Kit, CNTK, Apache MxNet, H20, Apple Core ML Python or Pytorch.

After the ML model 102 has been loaded, the environment initialiser model 210 applies a framework adjustment step in S212 wherein known countermeasures are retrieved from the countermeasure repositories in the repositories module 212. The known countermeasures comprise controls which are known to protect the confidentiality, integrity and availability of data and information systems. Examples of such countermeasures are distillation as a defence or retraining the ML model 102 for adversarial robustness, e.g. by training the model to optimise the weights and biases so that adversarial input does not disrupt the ML model 102.

In retrieving known countermeasures, the environment initializer accesses the countermeasures repository, and finds which countermeasure techniques are known to decrease a given model's vulnerability to an attack, which can be based on the architecture of the model or the priority of security over performance, etc.

The countermeasure repository stores countermeasures as a set of instructions to be carried out on a model, or on the service wrapping the model. For example, a distillation countermeasure can be instructions to start a distillation training process, and then create a new model to use instead of the current one. An API rate limiting countermeasure could be applied to the environment itself, with the stored countermeasure describing under which conditions and at what acceleration to decrease the rate.

In a step S214, the secure environment module 214 is deployed. This provides the execution environment for the attack designed by the user. The secure environment module 214 may, optionally, utilise a docker container or a virtual machine or a combinations of docker containers and virtual machines to provide a consistent platform and allow precise software versioning and reproducible environments where necessary. Other containerisation technologies may also be used to safely partition the resources of a compute node (running the environment) across multiple programs and processes and may also mimic separate OS environments like virtual machines do but without the associated overhead.

As a first step in providing the execution environment, the ML model system stack is initialised in a step S216. This is illustrated in FIG. 4. This ML model system stack provides an attack surface for the attack which has been configured using the attack design system 109. The ML model system stack illustrated in FIG. 4 is a stack which may be used to categorise attack vectors of the DL system. The stack provides a representation of the execution environment. ML model attacks can be categorised by which attack vector they use and can be modelled as a stack which transitions from the user-space software down to the hardware. The order of the layers of the stack illustrates the difficulty to leverage the attack, with API being the most straightforward.

The Web API is the highest level of the ML model system stack and is therefore exposed to the attack which has been configured using the attack design system 109. The compute framework provides the tools or libraries which are used in the ML model 102. Compute API covers the utilities and primitives implemented by the frameworks and utility software which is leveraged by ML models such as NVIDIA, CUDA, cuDNN, NVPROF and CUPTI. That is to say, whilst not providing frameworks themselves, compute API provides the set of libraries and primitives which underpin the libraries. In using the Compute API service, scalable, on demand access to libraries and primitives are provided and this can be provided whether the environment is provided as a virtual machine, a physical machine or a container. The OS (operating system) provides the software which manages the hardware, software and resources needed by the ML model 102. The hardware is the base level and provides the processing and registry resources needed by the OS.

At either of steps S214 or S216, environment countermeasures may be applied to the environment. Examples include specific firewall configurations, signature checks and checks for anomalous data.

The ML model system stack illustrated in FIG. 4 provides a standardised representation of a typical system stack which would be exposed to attackers seeking to attack an ML model 102.

The secure environment module 214 comprises a profiler which acts as the execution environment for the attack, where it is implemented as an operating system process. The profiler monitors all levels of the stack illustrated in FIG. 4 and records the data from all levels in the stack. The recorded data is stored in the attack repository in the attack repository in the repositories module 212.

The stack is a logical grouping of software components of a ML model. Allowing the attack to run un-sandboxed on the machine is not ideal for test reproducibility, safety of the machine, and complexity in managing the additional software components required for our platform to run (different versions of CUDA, etc). Container (e.g. Docker) and virtual machines are used to recreate the deployment scenario of the ML model configured by the user, and allow attacks to be run in a safe, dependency-managed sandbox. The virtualisation provided by the stack provides good test reproducibility. However, it is possible for the environment to be implemented without the additional container and virtual machines in that the environment can be “bare metal” fashion in that it becomes un-sandboxed. This enables the components of the stack to be monitored in a “bare-metal” fashion to more closely simulate a real-world implementation of an ML model.

When running in the sandboxed form, the stack utilises containerised components of the system represented in the stack such as the software running the web API, CUDA and Nvidia profiling tools. If components cannot be containerised, the entire system can be replicated in a virtual machine.

The machine hosting the attack design system 109 is the master process which controls the orchestration of the other modules. The user interacts with the user interface 208 to define the parameters for the attack, which sends requests to the master. As will be described herein, the different modules of the attack design system 109 are run in a specific order when an attack is being deployed. The code from the modules is therefore run in this order. The code either comprises a library being used in the master program, or as independently running processes, which the master can send requests to.

The profiler provides a dockerized and containerized representation of a deployed environment based on our system stack model (i.e. the one illustrated in FIG. 4), which is instantiated by the master but run as a separate process.

The attack repository provides a file system which stores one folder per attack. It includes the code (whether written in Python or otherwise) for the attack and the parameters for the attack. It also stores the resources required by those attacks, i.e. CACHE access, web API access, access to programs (external to the code), co-location programs and network connections. Each attack is coded in its entirety, as is access to resources the attack needs to execute. The difference between attacks means that they each execute differently and may require different parameters to be run, so each set of parameters is stored.

On initialisation of the ML model system stack (in step S216), the attack configured by attack design system 109 begins. This is step S218. The Web API in this respect acts like a honeypot to attract the attack configured using the attack design system 109.

On running the attack, the profiler should run through a checklist of sequences of operations, requests, input/output requests etc which are specified by the attacks folder in the attack repository. A dataset is also specified which is used in the attack. The dataset may be open or proprietary.

By way of summary, when the attack is run by the profiler, the process used to generate the attack seeks the required components (of the attack) in the repositories module 212. This may mean seeking out any countermeasures which are determined from step S212. The profiler uses this information to determine compatibility between components and countermeasures. The components are then loaded together to form the pipeline set out in the JSON hierarchy which forms the attack scenario.

The attack configuration may also specify an environment in which the attack needs to be executed. The environment may specify a library (such as the one found in a framework such as TensorFlow). The environment may specific a particular compiler for the code or even the hardware configuration.

In initialising the attack, the attack which is configured by the attack design system 109 is generated and the profiler monitors each level in the system stack. For example, during the attack, various requests to the hardware will be made and this will need to be recorded. The data at all levels of the stack is recorded to provide details of the attack. This enables the countermeasures which were retrieved in step S212 to be assessed and for the data from each level in the stack to be stored (during the attack).

The state of the attack is then stored in the executed repository in the repositories module 212. This is step S220. The data recorded during the attack is also recorded in the executed repository.

The attack, the required code to implement the attack, the parameters and the dataset for the attack, are stored in the attack repository. This means that the attack does not need to be recoded everytime it is needed. The attack design system 109 forms a wrapper for the attack and can be used to initialise each attack which is stored in the attack repository. The wrapper need not be reinstantiated every time an attack is begun.

Each of the repositories in the repositories module 212 comprises database software and tables which are used to implement the repository of the respected data.

In summary, the attack is configured and the attack scenario is defined in a suitable electronic data interchange format (e.g. JSON hierarchy), the wrapper functionality provided by attack design system 109 is then initialised in that the code, datasets etc for the attack is retrieved from the attack repository (the JSON hierarchy provides the parameters for the attack), the attack is then run. Each attack in the attack scenario may be run as a separate process by the attack design system 109, which means that more than a single attack can be run at once. That is to say, where an ensemble attack is defined in the attack scenario, or a pipeline of attacks, it is possible for the attack design system and particularly the secure environment to run them simultaneously, enabling the data for each attack to be recorded simultaneously.

By storing the data and code for each attack inside the attack repository, each attack can be redeployed on more than a single ML model or the same ML model multiple times.

During the attack, the weights and biases corresponding to the neurons in the neural network may be checked to see if they are being changed. This provides an idea of how the ML model 102 may be changed by an attack.

The stack illustrated in FIG. 4 may represent the real stack which may be used to implement the system in a server such as web server 101. The stack illustrated in FIG. 4 may be virtualised, i.e. a virtual machine may be used to provide this stack and which emulates the respective hardware and software. The virtual machine may be configured to emulate a particular CPU or graphics card configuration. However, we may also remove the virtual machine and containerised aspects of the attack implementation and perform “bare-metal” testing to emulate a real-implementation of the ML model.

The output from the attack may then be recorded in the executed repository and/or the attack repository. This may comprise CPU and GPU utilisation, memory and cache utilisation, network connection requests, the time of the various resource access requests, the amount of energy being consumed. For specific types of attack, more specific parameters may be required. For example, the DeepSniffer attack illustrated with reference to FIG. 3, the output may comprise evidence of specific architectural elements such as how many layers are in the model and what those layers represent in the model e.g. what they are and what they do such Convolutional layers, ReLu layers, Fully Connected layers, MaxPool layers. Overall, the recorded output may comprise time, resource utilisation, computational cost and the output generated by the attack.

After the attack has been completed, the result interpreter module 216 may be used to analyse the output data stored in the executed repository and/or the attack repository. The analysis may be used to determine the risk that the ML model 102 may be attacked (a measure of robustness may be determined) and the losses that may occur as a result of such an attack.

Specifically, the threat inference engine may apply probabilistic techniques to the data to determine the risk that the ML model (subject of the attack) would be attacked if deployed in a real web server (such as web server 101). This may be based on neural networks which are trained using real attack data. This may also be spaced on statistical analysis of the data. The threat inference engine may also provide inferential data regarding the risk the model may be exposed to specific threat actors. The threat inference engine may also be configured to recommend specific countermeasures.

Information regarding countermeasures can be gathered from literature and recorded in the countermeasure repository. Using this gathered information, we can train an ML model to associate the underlying properties of a model with which countermeasures and their configurations would best fit a use case, and make recommendations taking impacts on performance into account etc.

The threat inference engine may be configured to infer a rating of success of the attack. This will help the configuration of countermeasures. The threat inference engine may also apply techniques of statistical inference to analyse the likelihood of data loss, GDPR fines or high carbon footprint ML models. This can be used to provide a risk assessment of the ML model 102. The threat inference engine may be implemented using a neural network which receives inputs corresponding to the data captured during the attack configured by attack design system 109. The neural network provides an output which indicates the risk the ML model would be attacked.

The threat inference engine, profiler and repositories all run as independent processes from the master process referenced above.

The report generator may be configured to provide output reports regarding the attack which was executed on the ML model by the attack design system 109. The report may be transmitted to the user who configured the attack scenario using the attack design system 109.

The technical report is broken down by scenarios passed into the framework, denoting the attack run, the success it had, time taken to execute the attack, the result of the attack (resulted stolen model, predicted model architecture, etc.), and estimated cost of the stolen intellectual property associated with the model.

The data exporter generates the reports in a form specified by a user. For example, the user may specify the report is in comma-separated value (CSV) format.

The data transmitted between the respective modules is provided in a JSON format or in specific formats such as model checkpoint files where a JSON file cannot be used.

That is to say, the attack design system 109 is configured to test ML models and their security. The attack design system is configured to enable vulnerabilities in given models to be determined. It may also be used to determine the countermeasures which are most appropriate to counter those vulnerabilities.

The attack repository stores attacks as a set of instructions to be carried out on the system stack. This depends on the attack, but for a web API attack, the instructions would be to set up an adversarial ML instance in a target framework and with a target model, and describe what components are required to make queries to the target ML model.

We will now describe intrusion detection module 107. The intrusion detection module 107 may run as a separate and independent process from the attack design system 109. It provides a wrapper around a web API which may be used to access an ML model 102. The web server 101 comprises a web interface which receives the traffic into the server 101, including from the web API accessible to client devices 103, 104 and 105. The intrusion detection module 107 forms a proxy for the web interface in that all traffic entering the web server 101 passed through the intrusion detection module 107. In short, the intrusion detection module 107 is configured to apply a neural network to recognise patterns in traffic received through the Web API which are consistent with known attacks.

Advantageously, the intrusion detection module 107 is a separate process from the attack design system 109 as they can be used as independent components.

In order to describe the workings of the intrusion detection module 107, we will describe (with reference to FIG. 5) how client device 105 may attack the ML model 102 and how the attack design system and other data may be used to detect the attack and defend against the attack.

Repeating what is set out above, web server 101 hosts ML model 102 which can be accessed by client devices 103, 104 and 105. ML model 102 may provide output to those devices which comprises predictions (generated by ML model 102) based on input parameters which are provided to the ML model 102.

For example, ML model 102 may provide an image recognition service wherein the image data is passed into the ML model and a convolutional neural network is applied by the ML model 102 to recognise specific aspects of those images. The ML model 102 may apply other combinations of neural network to inputs which may be trained using any combination of unsupervised or supervised learning. Such specific aspects may be number plates in that that the client devices 103, 104 and 105 are being used for number plate recognition. Alternatively, the image data may relate to images of individuals and the ML model 102 may be deployed to determine whether the captured image data corresponds to specific individuals, such as criminals.

A user of client device 105 may opt to perform an evasion attack on an ML model 102 in a step S500 by capturing an image which would normally be submitted to the ML model 102 (in order to take advantage of its image recognition functionality) and modifying that image before it is submitted using the web API. Such an attack can be successful because the ML model 102 will have been trained to correlate certain types of pixels with intended variable. If, for example, a pixel is re-tailored in a specific way, i.e. by adding an imperceptible (to a processor) layer of noise, the model could be forced to alter its output, even if the image contains something of interest. This may mean the ML model is deceived into classifying an image of a criminal as an image of a person who is not of interest. The modified image data may be submitted in a step S502.

An example of a pixel being re-tailored in a facial recognition application may be a modification to change a face in the image so that it contains a feature which would still ensure the image is accepted into the ML model 102, but that the face would not be recognised by any facial recognition configured neural network as it contains, say, a second nose or an ear in an unusual position. This modification could be made by the client device 105 after the image has been captured.

The intrusion detection module 107 sits between the Web API (shown in FIG. 1a) and the web interface of web server 101 which receives all of the traffic which is directed at the ML model 102. In a step S504, the intrusion detection detects the request from client device 105 as it would detect all requests which are transmitted through the Web API.

That is to say, the Web API provides access to the ML model 102 and the intrusion detection module 107 is located like a proxy in front of the Web API. All queries directed through the ML model 102 are therefore passed through the intrusion detection module 107 and has access to all parameters associated with the request and the ML model 102. The intrusion detection module 107 also monitors all levels of the stack used to the implement the ML model 102.

The intrusion detection module 107 is configured to detect the modification to submitted image. This may be implemented using standard image processing techniques which are directed to specific features which may be added to an image to perform an evasion attack. Alternatively or additionally, the intrusion detection module 107 may be configured to look for markers indicative of suspicious intent. For example, if a third party news source indicates that a specific IP address is the source of an attack on another ML model then the intrusion detection module 107 may be configured to look for requests from that IP address. That is to say, the intrusion detection module 107 provides a layer in front of the ML model 102 which can be used to identify suspicious behavior before it happens. As it is a separate component from the system which is used to implement the ML model, it can be updated and configured more easily and more quickly. By providing a proxy in front of the web server which hosts the ML model 102, suspicious behaviour can be identified before it accesses the model.

Alternatively, the intrusion detection module 107 may be configured to detect the modification (to the image) if the attack design system 109 was used to test a similar evasion attack in steps S200 to S220 in that an attack scenario was tested using the attack design system where similar evasion attacks were tested in that the administrator of the ML model 102 understood that such an attack was possible and used the attack scenario on the ML model 102 to determine what such an attack would represent in terms of resource access, connection requests etc. For example, a similar evasion attack provided to the attack design system 109 may indicate a number of CACHE access requests exceeds a normal frequency. The intrusion detection module 107 may then be configured to monitor for such a frequency of CACHE access requests as this is likely to indicate a similar evasion attack on the ML model is happening.

In other words, the test of the attack using attack design system 109 enabled the administrator to extract data which illustrated the unusual behaviour such a modification would generate when the ML model 102 processes such a modified image. That is to say, as such an attack scenario (i.e. an evasion attack involving a modified image) has been tested using attack design system 109 and the data relating to the expected input and output, cache access patterns and patterns of accessing the model 102 has been measured, this attack can be retrieved from the attack repository and used to train a neural network to be run by the intrusion detection module 107 which looks for similar characteristics in the input data in order to identify the evasion attack before it accesses the ML model 102. That is to say, in a step S506, a neural network is run to identify patterns in the submitted image to indicate that the evasion attack is being attempted.

That is to say, the intrusion detection module 107 is configured to monitor system metrics such as, for example, GPU usage, memory access and the usage of other key system processes. Other metrics may be monitored such as, for example, counter metrics, CPU level metrics (e.g. cache misses) The intrusion detection module 107 may also monitor model metrics such as the number of inferences, time taken for each inference, the accuracy of a result from a known input (to determine whether poisoning has taken place) and the number of times a query which are made (i.e. is the same image being inputted over and over again).

These two areas represent metrics where malicious intent is likely to be represented. Continuous use of a model may indicate a potential stealing attempt as they look to build the model themselves by gathering small amounts of information about the model architecture each time.

If the neural network identifies the patterns indicative of an evasion attack, the request from client device 105 is denied. This is step S508. An alert is also sent to the administrator and the data which is captured is also kept as data which represents an attack. This may be used in further training of the neural network and may also be stored in the attack repository as data corresponding to a previous attack.

If the neural network does not identify the patterns indicative of an evasion attack, the request will be allowed into the stack which is used to run the ML model 102. This is step S510. This may be because the modification is so small that it would not register on the neural network. This may be because the modification is not significant enough in the image in that it does not add a feature which should not be in the image but rather it modifies a background feature, say.

The intrusion detection module 107 is also configured to monitor the stack used to implement the ML model 102. In monitoring the stack, the intrusion detection module 107 can identify unusual behaviour caused by a request, this may be in the form of unusual memory/CACHE access, unusual processor loading and utilisation.

The intrusion detection module 107 is configured to monitor the stack (in step S512) for such unusual behaviour and, upon determining unusual behaviour caused by a request, the intrusion detection module 107 generates an alert which is transmitted to the administrator.

This is step S514. The data from the request is then stored and used to train the neural network and also saved in the attack repository.

The behaviour monitored by the intrusion detection module 107 may be informed by an attack designer who is looking to test the ML model 102. The behaviour monitored may also be informed by news sources which report attacks on ML models or other services elsewhere.

For example, a DeepRecon attack on an ML model 102 can be determined based on the presence of a CACHE clearing request, repeated retrieval of the same data, accessing every class in a model and submitting data in a specified order. The intrusion detection module 107, on determining this behaviour, will generate an alert which will be transmitted to the administrator of the ML model 102. Additionally, the intrusion detection module 107 may monitor specific classifications utilised by the ML model 102 which are identified by an administrator as vulnerable. For example, an ML model 102 as described, may classify what is contained in an image to identify individuals of interest and, in training such a model, it may also be trained on images labelled as containing individuals who are not of interest or images of animals and other live objects not likely to be of interest. These classifications may be most vulnerable to attack as they are likely to provide inputs which indicate an individual in an image is not of interest. Therefore, the intrusion detection module 107 may monitor requests to determine whether specific characteristics of those classifications are present. The intrusion detection module 107 may also track hardware usage and inference from the model to determine whether it aligns with those classifications being present in the image, i.e. does the pooling step in the convolutional neural network indicate that perhaps an elephant is in the image, when it is likely to be a human being.

The intrusion detection module 107 may also be configured to respond to behaviour indicative of attacks which have been reported on other ML models.

That is to say, the intrusion detection module 107 is configured to monitor system metrics, hardware usage and the overall output of the ML model to determine the presence of suspicious activity. The overall output of the ML model may be monitored in the sense that, in the described example, if it provides output which indicates no human being is present in the image, this would indicate unusual behavior as all of the submitted images are likely to contain a human being.

If unusual behaviour is detected, the intrusion detection module 107 may halt the processing of the request and stop it from proceeding any further. Countermeasures, which may be indicated by the countermeasure repository, may then be deployed.

On generation of the alert, the intrusion detection module 107 may block or throttle the IP address of client device 105.

The intrusion detection module 107 may also restrict the amount of times the model can be accessed by a client device.

The data measured from the attack may then be transmitted to the threat inference engine where the risk and loss associated with the attack may be determined. The threat inference engine may also provide recommendations of countermeasures if the data associated with the attack is similar to an attack which has already been measured.

In summary, the attack design system 109 and the intrusion detection module 107 provide an end-to-end approach for detecting, profiling and applying countermeasures against attacks which are directed at machine learning and deep learning models.

The intrusion detection module 107 applies data analysis techniques to requests made to an ML model 102 to determine when attacks are underway. This enables countermeasures to be quickly deployed against an attack before the damage becomes too great.

Whilst the attack design system 109 can be used to feed data into the intrusion detection module 107, they are independent components.

The attack design system 109 enables the cyber-resilience of ML models of any sort (and any framework) to be evaluated in a framework independent manner.

The attack design system 109 and the intrusion detection module 107 can be used by a wide range of users through a user interface 208 which can be used to easily prepare attack scenarios.

The threat inference engine enables risk and loss associated with a specific ML model to be estimated.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A computer-implemented method of detecting an attack on a Machine Learning (ML) model operating environment hosted on a processing medium, the method implemented on a processing resource, the method comprising:
monitoring all requests from computing devices to the processing medium;
determining that a request from at least one computing device is a request to access an ML model operating environment;
determining from the request, the presence of data indicative of an attack and, if data indicative of an attack can be determined from the request, rejecting the request and, if data indicative of an attack cannot be determined from the request, enabling the request to access the ML model and monitoring the ML model operating environment to determine patterns of resource use indicative of suspicious behavior.

2. A method according to claim 1, wherein monitoring the ML model operating environment to determine patterns of resource use indicative of suspicious behavior comprises monitoring system metrics.

3. A method according to claim 1, wherein monitoring the ML model operating environment to determine patterns of resource use indicative of suspicious behavior comprises monitoring hardware usage.

4. A method according to claim 1, wherein monitoring the ML model operating environment to determine patterns of resource use indicative of suspicious behavior comprises monitoring output from the ML model.

5. A method according to claim 1, wherein monitoring the ML model operating environment to determine patterns of resource use indicative of suspicious behavior comprises monitoring the use of classifications in the ML model identified as vulnerable.

6. A method according to claim 1, wherein the determination of the presence of data indicative of an attack comprises the application of a neural network to the request data.

7. A method according to claim 6, wherein the neural network is trained using data from a pre-run attack.

8. A method according to claim 7, wherein the data from the pre-run attack comprises data relating to an attack devised by an administrator of the ML model and applied to the ML model.

9. A computer-implemented method of assessing the effect of an attack on a machine learning model, the method implemented on a processing resource, the method comprising the steps of:
receiving parameters describing the configuration of an attack;
retrieving a machine learning (ML) model and loading it into an environment;
retrieving a dataset and loading it into said model;
retrieving data describing said attack.

10. A method according to claim 9, wherein the model is translated into a model representation language.

11. A method according to claim 10, wherein the model representation language enables the ML model to be analysed in a framework independent manner.

12. A method according to claim 10, wherein the method further comprises monitoring the environment whilst the attack is executed to determine attack data; and recording the attack as data describing the attack.

13. A method according to claim 12, wherein the monitoring of the environment comprises monitoring at least one of: resource usage, system usage, network connections, input and output from the ML model and parameters of the ML model.

14. A method according to claim 9, wherein the method further comprises utilising the data to train a neural network to determine the presence of the attack or a similar attack.

15. A method according to claim 9, wherein the method further comprises:
analysing the data from the said attack by scoring the robustness of the model against a predefined suite of ML model attacks;
determining risk and loss associated with the attack on the ML model.

16. A method according to claim 15, wherein the method further comprises:
analysing the data from the said attack to identify potential security vulnerabilities;
identifying improvements in the model to enable resistance against the identified security vulnerabilities.

17. A computing system comprising a processing resource, configured to:
receive parameters describing the configuration of an attack;
retrieve a machine learning (ML) model and load it into an environment;
retrieve a dataset and load it into said model; and
retrieve data describing said attack.

18. A computing system according to claim 17, wherein the processing resource is further configured to monitor the environment whilst the attack is executed to determine attack data; and record the attack as data describing the attack.

19. A computing system according to claim 17, wherein the processing resource is further configured to utilise the data to train a neural network to determine the presence of the attack or a similar attack.

20. A computing system according to claim 17, wherein the processing resource is further configured to:
analyse the data from the said attack by scoring the robustness of the model against a predefined suite of ML model attacks; and
determine risk and loss associated with the attack on the ML model.
